(19) United States
(12) Patent Application Publication
(10) Pub. No.: US 2011/0065824 A1
(43) Pub. Date: Mar. 17, 2011

(54) CURABLE COMPOSITION FOR IMPRINTS

(75) Inventors: Akinori FUJITA, Haibara-gun (JP); Tomotaka Tsuchimura, Haibara-gun (JP)

(73) Assignee: FUJIFILM Corporation, Tokyo (JP)

(21) Appl. No.: 12/881,830

(22) Filed: Sep. 14, 2010

(30) Foreign Application Priority Data
Sep. 15, 2009 (JP) 2009-213408

(51) Int. Cl. C08F 2/50; C08J 7/04

(52) U.S. Cl. 522/28; 427/510; 522/39; 522/50; 522/53; 522/63; 522/65; 524/606

(57) ABSTRACT

A curable composition for imprints excellent in adhesiveness to a substrate is disclosed. The composition comprises an oxime ester compound (A) and a polymerizable monomer (B), and the content of the polymerizable monomer (B) falls within a range of 80% by mass or more, relative to all ingredients of the composition except for a solvent.

### CROSS-REFERENCE TO RELATED APPLICATIONS

The present application claims the benefit of priority from Japanese Patent Application No. 213408/2009 filed on Sep. 15, 2009, the contents of which are herein incorporated by reference in their entirety.

### FIELD OF THE INVENTION

The invention relates to a curable composition for imprints excellent in adhesion to substrate, and further, relates a curable composition for imprints which needs a small peeling force to a mold and has a high curing sensitivity. Particularly, the invention relates to a curable composition for imprints suitable for photo nanoimprints.

### BACKGROUND OF THE INVENTION

J. Vac. Sci. Technol. B 16(6), November/December 1996 reports that pattern formation according to photo nanoimprints can be carried out by photo-curing a composition comprising an acrylate monomer and a photopolymerization initiator. Although J. Vac. Sci. Technol. B 16 (6), November/December 1996 includes the description concerning pattern formation according to an imprinting method, it does not include the detail description concerning adhesiveness of cured resin to a substrate in releasing from a mold, which adhesiveness is important industrially. Enhancement of adhesiveness between cured resin and substrate in an imprinting step has been variously investigated. For example, JP-A-2007-84625 and JP-A-2008-105414 disclose that adhesiveness to a substrate is enhanced by adding a silane coupling agent.

Trouble concerning adhesiveness of cured resin to a substrate in the imprinting step is also closely related to peeling force (peelability) between cured resin and a mold. Concerning enhancement of releasability, JP-A-2007-1250 and JP-A-2005-84561 report that fluorine series material and silicon series material are used as a release agent. Since those methods improve the property by adding such an additive, those methods are capable of wide application. However, there is a case where fluorine atoms and silicon atoms can not be used depending on its use because those methods have problems for adhesion to a coating device and contamination of a device in etching cured membrane.

On the other hand, JP-A-2009-128759 discloses that oxime ester is used for a curable composition for imprints.

### SUMMARY OF THE INVENTION

As mentioned above, the adhesiveness to a substrate has been investigated, however, it is not sufficient. The object of the invention relates to solve such a conventional problem which the related art had, and to provide a curable composition for imprints excellent in adhesiveness to a substrate.

Heretofore, in order to enhance adhesiveness to a substrate, a silane coupling agent has been used. However, the inventors have investigated and found that that addition of only a silane coupling agent does not attain sufficient adhesiveness to a substrate. In addition, when adhesiveness to a substrate is tried to enhance, peeling force from a mold tends to be larger.

Under such a situation, the inventors have earnestly investigated and found that a curable composition for imprints excellent in adhesiveness to a substrate can be obtained by using an oxime ester compound as a photopolymerization initiator and adjusting the content of polymerizable monomer to 80% by mass or more, relative to the amount of the composition, regardless of using a silane coupling agent. Thereby, the inventors have completed the invention. Specifically, the aforementioned problem can be solved by the following means.
(1) A curable composition for imprints comprising an oxime ester compound (A) and a polymerizable monomer (B), wherein the content of the polymerizable monomer (B) falls within a range of 80% by mass or more, relative to all ingredients of the composition except for a solvent.
(2) The curable composition for imprints according to (1), which further comprises a silane coupling agent (C).
(3) The curable composition for imprints according to (1), which further comprises a silane coupling agent (C) having a carbon-carbon unsaturated bond.
(4) The curable composition for imprints according to (1), which further comprises a silane coupling agent (C) having a carbon-carbon unsaturated bond and a nitrogen atom.
(5) The curable composition for imprints according to (1), which further comprises a silane coupling agent (C) having a carbon-carbon unsaturated bond and an amino group.
(6) The curable composition for imprints according to any one of (1) to (6), wherein the oxime ester compound (A) is a compound represented by the following formula (1), or a compound represented by the following formula (2):

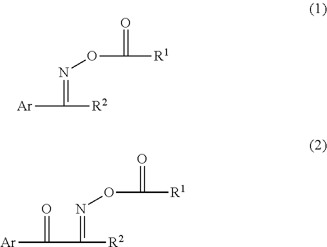

wherein Ar is a hydrocarbon series aromatic ring or a heteroaromatic ring, R¹ is an alkyl group, an aromatic group, or an alkoxy group, R² is a hydrogen atom or an alkyl group, and R² may bond to Ar to form a ring.
(7) The curable composition for imprints according to (1) to (5), wherein the oxime ester compound (A) is a compound represented by the following formula (3), a compound represented by the following formula (4), or a compound represented by the following formula (5):

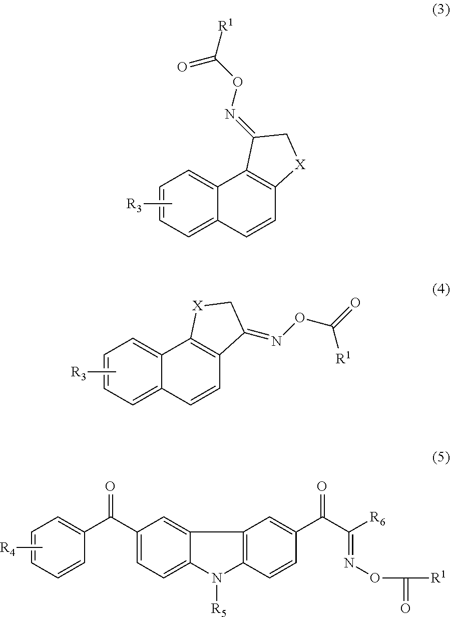

wherein R¹ is an alkyl group, an aromatic group, or an alkoxy group, X is —CH₂—, —C₂H₄—, —O—, or —S—, R³ is a hydrogen atom, or a halogen atom, R⁴ is a hydrogen atom, an alkyl group, a phenyl group, an alkyl-substituted amino group, an arylthio group, an alkylthio group, an alkoxy group, an aryloxy group, or a halogen atom, R⁵ is a hydrogen atom, an alkyl group, or an aryl group, and R⁶ is an alkyl group.
(8) The curable composition for imprints according to any one of (1) to (7), wherein the polymerizable monomer (B) is a (meth)acrylate.
(9) The curable composition for imprints according to any one of (1) to (8), which further comprises a release agent.
(10) The curable composition for imprints according to any one of (1) to (9), which has a viscosity of from 3 to 30 mPa·s.
(11) The curable composition for imprints according to any one of (1) to (10), which further comprises a sensitizer.
(12) The curable composition for imprints according to any one of (2) to (11), wherein the content of the silane coupling agent falls within a range of 0.1 to 20% by mass, relative to all ingredients of the composition except for a solvent.
(13) The curable composition for imprints according to any one of (1) to (12), wherein the oxime ester compound (A) is selected from the following PI-1 to PI-9:

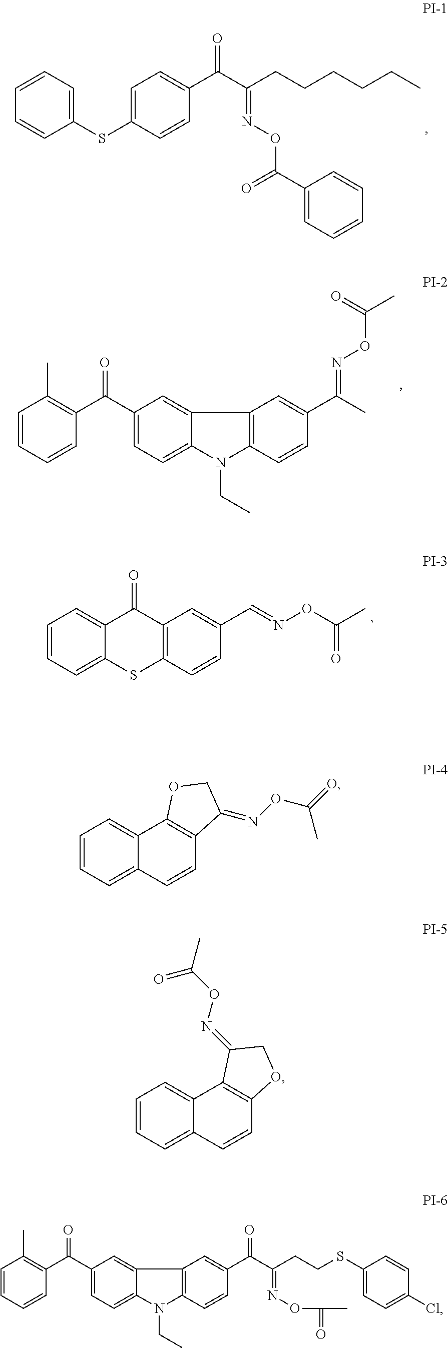

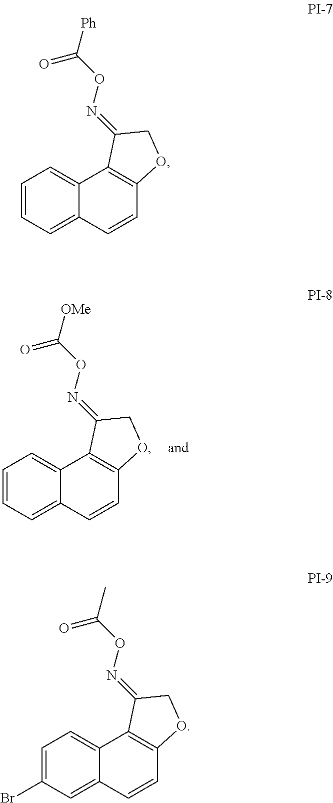

(14) The curable composition for imprints according to any one of (2) to (13), wherein the silane coupling agent is selected from the following SA-1 to SA-3:

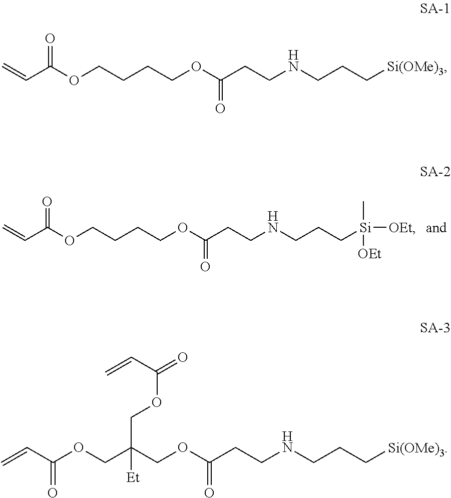

(15) The curable composition for imprints according to any one of (1) to (14), wherein the content of the oxime ester compound falls within a range of 0.1 to 5% by mass, relative to all ingredients of the composition except for a solvent.
(16) The curable composition for imprints according to any one of (1) to (15), wherein the content of the oxime ester falls within a range of 0.1 to 5% by mass, relative to all ingredients of the composition except for a solvent, and the oxime ester compound (A) is a compound represented by the following formula (3), a compound represented by the following formula (4), or a compound represented by the following formula (5):

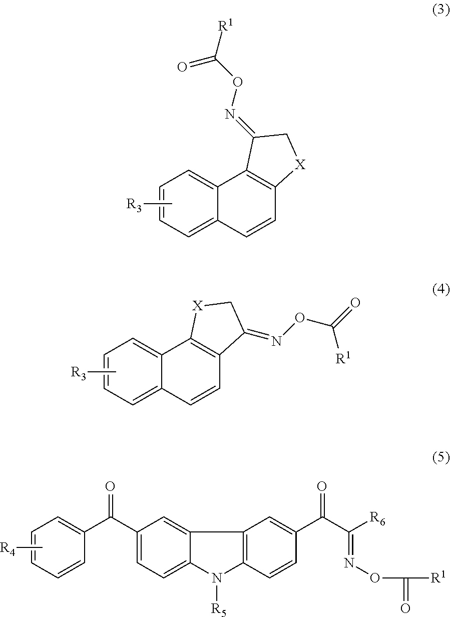

wherein R¹ is an alkyl group, an aromatic group, or an alkoxy group, X is —CH₂—, —C₂H₄—, —O—, or —S—, R³ is a hydrogen atom, or a halogen atom, R⁴ is a hydrogen atom, an alkyl group, a phenyl group, an alkyl-substituted amino group, an arylthio group, an alkylthio group, an alkoxy group, an aryloxy group, or a halogen atom, R⁵ is a hydrogen atom, an alkyl group, or an aryl group, and R⁶ is an alkyl group.
(17) The curable composition for imprints according to any one of (1) to (16), wherein the content of the oxime ester falls within a range of 0.1 to 5% by mass, relative to all ingredients of the composition except for a solvent; the oxime ester compound (A) is a compound represented by the following formula (3), a compound represented by the following formula (4), or a compound represented by the following formula (5):

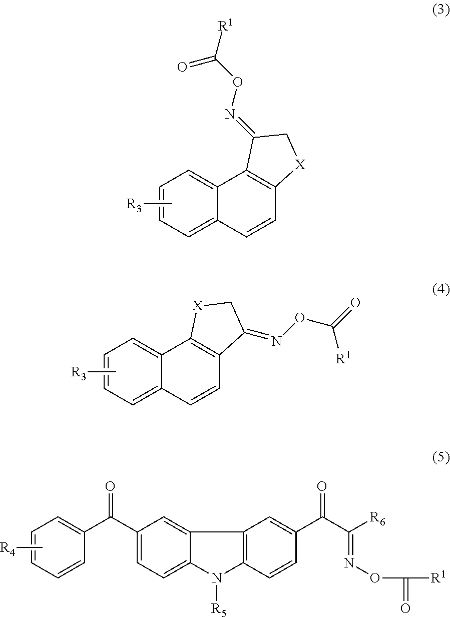

wherein R¹ is an alkyl group, an aromatic group, or an alkoxy group, X is —CH₂—, —C₂H₄—, —O—, or —S—, R³ is a hydrogen atom, or a halogen atom, R⁴ is a hydrogen atom, an alkyl group, a phenyl group, an alkyl-substituted amino group, an arylthio group, an alkylthio group, an alkoxy group, an aryloxy group, or a halogen atom, R⁵ is a hydrogen atom, an alkyl group, or an aryl group, and R⁶ is an alkyl group; and
which further comprises a silane coupling agent (C) having a carbon-carbon unsaturated bond and an amino group.
(18) A cured product, obtained by curing the curable composition for imprints of any one of (1) to (17).
(19) A method for producing a cured product, which comprises applying the curable composition for imprints of any one of (1) to (17) onto a substrate to form a patterning layer thereon, pressing a mold against the surface of the patterning layer, and irradiating the patterning layer with light.
(20) The method for producing a cured product according to (19), which further comprises heating the light-irradiated pattering layer.

### DESCRIPTION OF SPECIFIC EMBODIMENTS

The contents of the invention are described in detail hereinunder. In this description, the numerical range expressed by the wording “a number to another number” means the range that falls between the former number indicating the lowermost limit of the range and the latter number indicating the uppermost limit thereof.

In this description, “(meth)acrylate” means acrylate and methacrylate; “(meth)acrylic” means acrylic and methacrylic; “(meth)acryloyl” means acryloyl and methacryloyl. In the invention, monomer is differentiated from oligomer and polymer, and the monomer indicates a compound having a weight-average molecular weight of at most 1,000. In this description, “functional group” means a group participating in polymerization.

Regarding the expression of “group (atomic group)” in this description, the expression with no indication of “substituted” or “unsubstituted” includes both “substituted group” and “unsubstituted group”. For example, “alkyl group” includes not only an alkyl group not having a substituent (unsubstituted alkyl group) but also an alkyl group having a substituent (substituted alkyl group).

“Imprint” referred to in the invention is meant to indicate pattern transfer in a size of from 1 nm to 10 mm and preferably meant to indicate pattern transfer in a size of from about 10 nm to 100 μm (nanoimprint).

The curable composition for imprints of the invention can be widely applied to a field applicable to photo nanoimprint lithography. According to the invention, there is an advantage in that a curable composition for imprints having the following features is easily provided.

(1) As excellent in solution flowability at room temperature, the composition can readily flow into the cavity of the recesses part of a mold and hardly takes air therein to cause bubble defects; and after photo-cured, the composition leaves few residues in both the recesses and the projections of a mold.

(2) After cured, the cured film is excellent in mechanical properties, adhesiveness between the coating film and the substrate, and releasability of the coating film from a mold. Therefore, when the cured film is peeled away from a mold, it is free from troubles of pattern deformation or coating film surface stringiness to cause surface roughness, and the cured film may form a good pattern (good patterning accuracy)

(3) As excellent in coating uniformity, the composition is suitable to the filed of application to large-size substrates and micropatterning thereon.

(4) The composition is excellent in light transmittance, residual membrane performance, mechanical performance such as scratched resistance (curability), and solvent resistance, the composition is preferably used for various permanent films.

Thus, the composition of the invention is favorably applied to semiconductor integrated circuits and components of liquid-crystal display devices (especially to microfabrication for thin-film transistors of liquid-crystal displays, protective films of liquid-crystal color filters, spacers and other components of liquid-crystal display devices, etc.) to which, however, conventional compositions are heretofore difficult to apply; and in addition, the composition of the invention is further applicable to production of any others, widely for example, partitioning materials for plasma display panels, flat screens, microelectromechanical systems (MEMS), sensor devices, optical discs, magnetic-recording media such as high-density memory discs, optical parts such as diffraction gratings and relief holograms, nanodevices, optical devices, optical films, polarization devices, organic transistors, color filters, overcoat layers, pillar materials, rib materials for liquid-crystal alignment, microlens arrays, immunoassay chips, DNA separation chips, microreactors, nanobio devices, optical waveguides, optical filters, photonic liquid crystals, etc.

The curable composition for imprints of the invention (hereinafter, may be referred to as “the composition of the invention”) comprises an oxime ester compound (A) and a polymerizable monomer (B), which comprises the polymerizable monomer (B) in an amount of 80% by mass or more, relative to all ingredients except for a solvent. Hereinafter, those are described in detail below.

### <(A)Oxime Ester Compound>

The oxime ester compound used in the invention is preferably a photo radical generator (photopolymerization initiator). Examples of such an oxime ester compound include compounds described in JP-A-2000-80068, JP-A-2001-233842, JP-T-2004-534797, JP-A-2007-231000, or JP-A-2009-134289.

The oxime ester compound (A) is preferably a compound represented by the following formula (1) or a compound represented by the following formula (2):

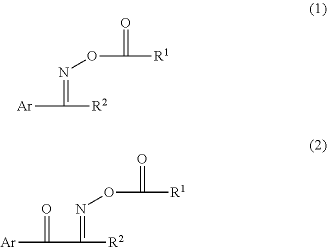

wherein Ar is a hydrocarbon series aromatic ring or a heteroaromatic ring, R¹ is an alkyl group, an aromatic group, or an alkoxy group, R² is a hydrogen atom or an alkyl group, and R² may bond to Ar to form a ring. The aromatic group in R¹ is preferably an aromatic hydrocarbon group, further more preferably a benzene series group.

Ar is a hydrocarbon series aromatic ring or a heteroaromatic ring, and is preferably a benzene ring, a condensed benzene ring, a heteroaromatic ring, more preferably a benzene ring, a naphthalene ring, or a carbazole ring, more preferably a naphthalene ring which bonds to R² to form a ring, or a carbazole ring which bonds to R² to form a ring.

R¹ is an alkyl group, an aromatic group, or an alkoxy group, preferably a methyl group, an ethyl group, a benzyl group, a phenyl group, a naphthyl group, a methoxy group, or an ethoxy group, more preferably a methyl group, an ethyl group, a phenyl group, or a methoxy group.

R² is a hydrogen atom, or an alkyl group, preferably a hydrogen atom, or a substituted-alkyl group, more preferably a hydrogen atom, a substituted-alkyl group which bonds to Ar to form a ring, or a toluene thioalkyl group.

The oxime ester compound (A) is further more preferably a compound represented by the following formula (3), a compound represented by the following formula (4), or a compound represented by the following formula (5):

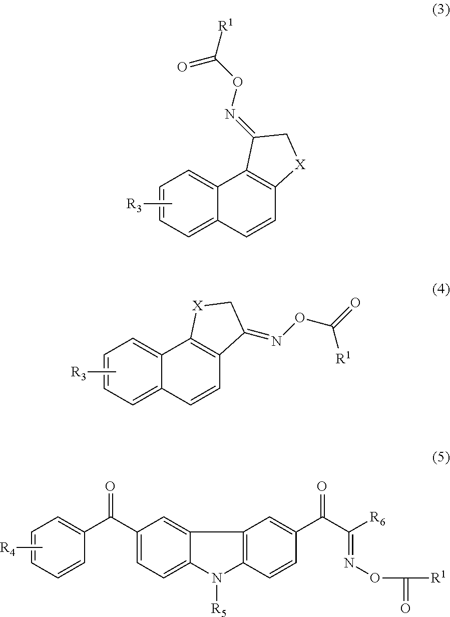

wherein R¹ is an alkyl group, an aromatic group, or an alkoxy group, X is —CH₂—, —C₂H₄—, —O—, or —S—, R³ is a hydrogen atom, or a halogen atom, R⁴ is a hydrogen atom, an alkyl group, a phenyl group, an alkyl-substituted amino group, an arylthio group, an alkylthio group, an alkoxy group, an aryloxy group, or a halogen atom, R⁵ is a hydrogen atom, an alkyl group, or an aryl group, and R⁶ is an alkyl group.

R¹ is an alkyl group, an aromatic group, or an alkoxy group and is the same as R¹ in the formula (1) or (2) and the preferred range is defined as the same as R¹ in the formula (1) or (2).

R⁴ is a hydrogen atom, an alkyl group, a phenyl group, an alkyl-substituted amino group, an arylthio group, an alkylthio group, an alkoxy group, an aryloxy group, or a halogen atom, preferably a hydrogen atom, an alkyl group, a phenyl group, an arylthio group, or a halogen atom, more preferably a hydrogen atom, an alkyl group, an arylthio group, or a halogen atom, furthermore preferably a hydrogen atom, an alkyl group, or a halogen atom. The alkyl group is preferably an alkyl group having 1 to 5 carbon atoms, more preferably a methyl group or an ethyl group. The halogen atom is preferably a chlorine atom, a bromine atom, or a fluorine atom.

R⁵ is preferably a hydrogen atom, an alkyl group, or an aryl group, preferably an alkyl group. The alkyl group is preferably is an alkyl group having 1 to 5 carbon atoms, more preferably a methyl group or an ethyl group.

R⁶ is an alkyl group, preferably an alkyl group having 1 to 5 carbon atoms, more preferably a methyl group, or an ethyl group.

Hereinafter, the oxime ester compounds preferably used in the invention are exemplified, to which, however, the oxime ester compounds used in the invention is not limited.

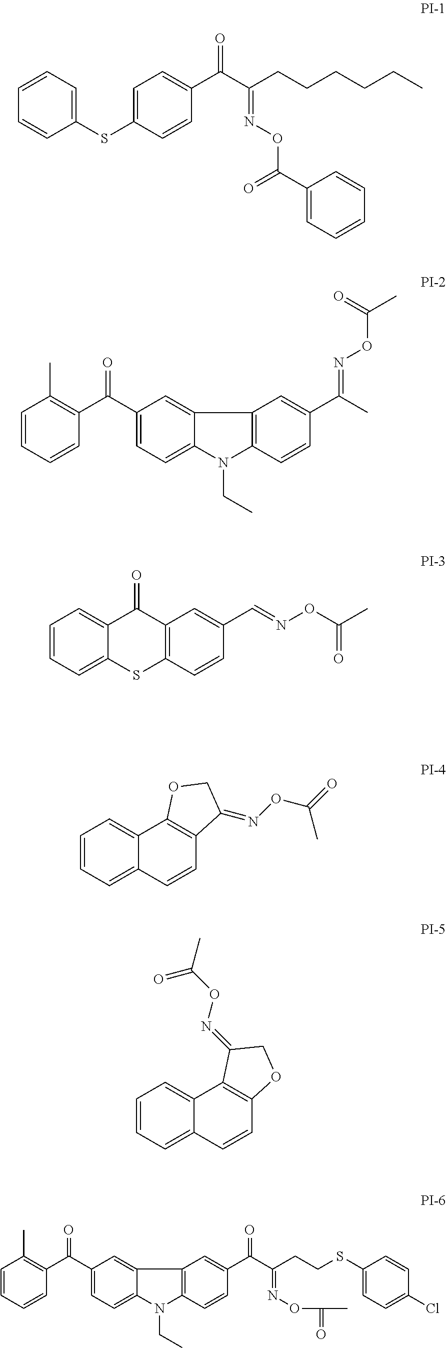

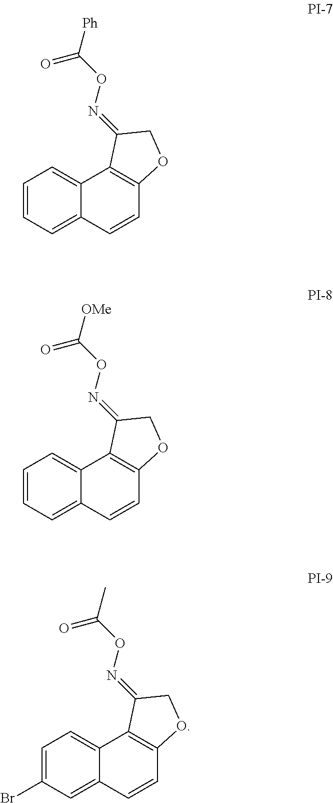

The curable composition for imprints in the invention preferably comprises the oxime ester compound in an amount of 0.01 to 10% by mass, more preferably 0.1 to 5% by mass, relative to all ingredients except for a solvent.

The curable composition may comprise two or more kinds of the oxime ester compounds. In the case of comprising two or more kinds of the oxime ester compounds, the total content is preferably the above content.

Further, in addition to the radical photopolymerization initiator, a photosensitizer may also be added to the curable composition for imprints of the invention for regulating the UV-region wavelength. Typical sensitizers usable in the invention are those disclosed in J. V. Crivello, Adv. in Polymer Sci., 62, 1 (1984), concretely including pyrene, perylene, acridine orange, thioxanthone, 2-chlorothioxanthone, benzoflavin, N-vinylcarbazole, 9,10-dibutoxyanthracene, anthraquinone, coumarin, ketocoumarin, phenanthrene, camphorquinone, phenothiazine derivatives, etc. The photosensitizer is preferably added to be in an amount of 50 to 500% by mass, relative to the content of the photopolymerization initiator.

### <(B)Polymerizable Monomer>

The curable composition for imprints of the invention comprises a polymerizable monomer for the purpose of enhancing a viscosity of the composition, hardness of the obtained membrane and flexibility of the obtained article.

The curable composition for imprints for the invention comprises such a polymerizable monomer in an amount of 80% by mass or more, relative to the ingredients thereof except for a solvent, preferably in an amount of 80 to 99% by mass, more preferably in an amount of 90 to 99% by mass.

Examples of the above polymerizable monomer include a polymerizable unsaturated monomer having 1 to 6 of ethylenic unsaturated bond groups, a compound having an oxirane ring (epoxy compound), a vinyl ether compound, a styrene derivative, a compound comprising a fluorine atom, propenyl ether or butenyl ether. From the viewpoints of accelerating its curability at light-irradiation, a polymerizable unsaturated monomer having 1 to 6 of ethylenic unsaturated bond groups is preferable, a monofunctional or polyfunctional (meth)acrylate is more preferable.

The polymerizable monomer is specifically exemplified by the compounds described in JP-A-2009-206197, paragraph 0066 to 0083.

The curable composition of the invention preferably comprises both of a monofunctional (meth)acrylate and a polyfunctional (meth)acrylate as a polymerizable monomer, more preferably comprises a bifunctional (meth)acrylate and/or a trifunctional (meth)acrylate in a total amount of 40% by mass of more, relative to the content of all polymerizable monomers therein, further more preferably comprises bifunctional and/or trifunctional (meth)acrylate in a total amount of 60% by mass of more, relative to the content of all polymerizable monomers therein. The upper limit is not specifically limited and is generally 90% by mass or less, preferably 80% by mass or less.

### <(C) Silane Coupling Agent>

The silane coupling agent used in the composition of the invention is exemplified by the compound described in JP-A-2009-206197, paragraph 0101.

The silane coupling agent used in the invention is particularly preferably has an alkoxysilyl group (a silane coupling group) and an organic group having 4 or more carbon atoms. The upper limit of the number of carbons in the organic group is not specifically limited, and is generally 20 or less.

Of those, the silane coupling agent is preferablely a silane coupling agent having a carbon-carbon unsaturated bond. The carbon-carbon unsaturated bond may be a carbon-carbon double bond or a carbon-carbon triple bond, preferably a carbon-carbon double bond.

The molecular weight of the silane coupling agent used in the invention is preferably 100 to 600, more preferably 150 to 500.

The silane coupling agent comprising a carbon-carbon unsaturated bond is exemplified by γ-acryloyloxy propyl trimethoxysilane, γ-acryloyloxy propyl triethoxysilane, γ-methacryloyloxy propyl trimethoxysilane, and γ-methacryloyloxy propyl triethoxysilane.

The silane coupling agent in the invention is preferably a silane coupling agent having both of a carbon-carbon unsaturated bond and a nitrogen atom, more preferably a silane coupling agent having both of a carbon-carbon unsaturated bond and an amino group.

Such a silane coupling agent having both of a carbon-carbon unsaturated bond and an amino group is exemplified by the following structure. The silane coupling agents shown below can be readily prepared by mixing a (meth)acrylate compound having two or more functional groups and a silane coupling agent having an aminopropyl group.

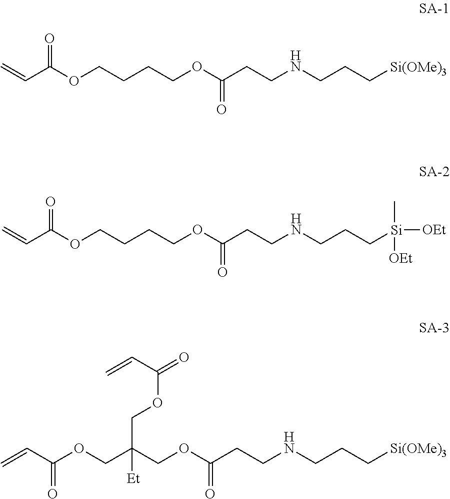

The composition of the invention preferably comprises the above mentioned silane coupling agent preferably in an amount of 0.1 to 20% by mass, more preferably in an amount of 1 to 10% by mass.

### <Release Agent>

For the purpose of further enhancing the releasability thereof, the composition of the invention may contain a release agent. Concretely, the release agent is added to the composition for the purpose of smoothly releasing a mold pressed to the layer of the composition of the invention not causing surface roughening of the resin layer and not deforming the pattern formed on the layer. The release agent may be any known release agent, including, for example, silicone release agents, solid waxes such as polyethylene wax, amide wax, Teflon® powder, etc., as well as fluorine-containing compounds, phosphate compounds, etc. The release agent may be previously applied to the surface of a mold.

Specific examples of the release agent include the release agent described in JP-A-2009-206197, paragraph 0094 to 0099.

In case where the release agent is added to the composition of the invention, its content is preferably from 0.001 to 10% by mass of the total amount of the composition, more preferably from 0.01 to 5% by mass. When the proportion of the release agent falls within the range of 0.01 to 5% by mass, then the mold releasability of the layer of the curable composition for imprints of the invention may be enhanced; and a problem of surface roughening of the coating layer as the composition may be repelled in coating, or other problems of worsening the adhesiveness of the composition to substrates themselves or to adjacent layers such as deposit layers in the products or breaking the coating film in transferring (as the film strength is too weak) is suppressed.

### Other Ingredients

The composition of the invention may contain, if desired, polymer, surfactant, antioxidant, organic metal coupling agent, polymerization inhibitor, UV absorbent, light stabilizer, antiaging agent, plasticizer, adhesion promoter, thermal polymerization initiator, colorant, elastomer particles, photoacid enhancer, photobase generator, basic compound, flowability promoter, defoaming agent, dispersant, etc. Those additives may be referred to as the description in JP-A-2009-206197.

The curable composition for imprints of the invention may comprise a solvent, preferably is a substantively solventless type composition. The “substantively solventless type composition” herein means a composition which does not substantively comprise any organic solvent. Specifically, in the composition of the invention, the content of an organic solvent is 3% by mass or less. Since the composition of the invention may comprise monofunctional or difunctional polymerizable monomer as a reactive diluent, the composition does not necessarily comprise an organic solvent for dissolving ingredients in the composition of the invention. When the composition does not comprise an organic solvent, there is no need for a baking step for volatilizing solvents, and therefore, there is more advantageous merit such as effective simplification of process. Therefore, in the composition of the invention, the content of the organic solvent is preferably 3% by mass or less, more preferably 2% by mass or less, further more preferably 0% by mass. As thus-mentioned, the composition of the invention does not necessarily comprise an organic solvent. However, an organic solvent may be arbitrarily added in the case where a compound which can not dissolve in the reactive diluent is dissolved in the composition of the invention, or in the case where the viscosity of the composition is need to be slightly adjusted. The organic solvent preferably used in the composition of the invention may be a solvent which is generally used in a curable composition for photoimprints or in photo resist, or may be a solvent which dissolves and uniformly disperses the compound used in the invention, and is not specifically limited as far as such a solvent does not react with another ingredient in the composition.

Examples of the organic solvent include solvents disclosed in JP-A-2009-206197, paragraphs 0122 to 0124.

The viscosity at 25° C. of the curable composition of the invention is preferably 3 to 30 mPa·s. The viscosity of the invention is a viscosity at 25° C. unless specifically defined. By setting the viscosity at 25° C. of the composition to 3 to 30mPa·s, the curable composition of the invention can obtain various appropriate fabrication performances such as forming performance of micropattern having projections and recesses, coatability or the like before cured, and the composition can obtain various excellent performances of a coated film for resolution, line edge roughness property, residual property and adhesiveness to a substrate and other points after cured. It is not good that the viscosity of the curable composition for imprints is merely low. It was found that the object of the invention can be achieved as far as the composition has a particular viscosity range, that is 3 to 30 mPa·s. Specifically, when the viscosity of the photo curable composition of the invention is 3 mPa·s or more, then the composition may be free from a problem of coating failure on substrates and the mechanical strength of the coating film may be high. Concretely, the composition is free from a problem of coating unevenness and a problem of flowing out on substrate in application thereto. On the other hand, when the viscosity of the composition is at most 30 mPa·s, then it is favorable because of the following reasons. When a mold having a micropattern having projections and recesses is airtightly attached to the composition, the composition may well flow into the cavity of the concave part of the mold not taking bubbles therein, and therefore, the composition is free from a problem of bubble defects and, after cured, the composition leaves few residues in the concave part of the mold.

The viscosity of the curable composition for imprints of the invention is preferably 5 to 27 mPa·s, more preferably 7 to 25 mPa·s. The curable composition for imprints of the invention is preferably a composition which is substantially free from a solvent and its viscosity is 3 to 30 mPa·s.

In general, the viscosity of the composition may be controlled by blending various monomers, oligomers and polymers having a different viscosity. For planning the viscosity of the curable composition for photoimprints of the invention so as to fall within the above-mentioned range, preferably, a monomer compound having a viscosity of 10 mPa·s or less is added to control the viscosity of the composition.

### [Method for Producing Cured Product]

A method for producing a cured product using the curable composition for imprints of the invention is described below (particularly a method for producing a micropattern with projections and recesses). A micropattern can be formed by applying the curable composition for imprints of the invention onto a substrate or a support (base) to form a patterning layer thereon, pressing a mold against the surface of the patterning layer, and irradiating the patterning layer with light to cure the composition of the invention. Particularly, the method of the invention preferably comprises heating the light-irradiated pattering layer to increase the curing degree of the cured product.

The cured product obtained by the method for producing a cured product of the invention is excellent in pattern transfer accuracy, curability and light transmittance, and is preferably applicable to a protection film for a liquid crystal color filter, a spacer, and other components for liquid crystal display.

Concretely, the method comprises applying a patterning layer comprising the composition of the invention on a substrate (base or support), drying it to form a layer of the composition of the invention (a patterning layer) as a pattern-receiver [the patterning layer is formed on the substrate], pressing a mold onto the surface of the patterning layer of the pattern-receiver, processing for mold pattern transfer, and curing a patterning layer having a fine pattern having projections and recesses with irradiation with light and heat. The irradiation with light and heat can be conducted twice or more. Lamination and multi-patterning are possible by the photoimprint lithography with the patterning method of the invention (method for producing a cured product), which can be used with a normal thermal imprint.

The curable composition for imprints of the invention is possible to form a micropattern according to photo imprinting method at low cost and at high accuracy. Therefore, that which has been formed according to conventional photo lithography techniques can be formed at higher accuracy and at low cost. For example, the composition may be applied onto a substrate or a support, then the layer of the composition may be exposed to light, cured and optionally baked, to thereby apply a permanent film such as an overcoat layer, an insulation film or etching resist such as a semiconductor integrated circuit, recording material or a plat panel display.

The pattern obtained by using the curable composition for imprints is excellent in etching performance, and therefore, the composition for the invention is preferably used as an etching resist for dry etching using carbon fluoride or the like. A cured product of the curable composition for imprints is excellent in light-transmissibility. Therefore, the composition of the invention is preferably used for thereby forming a permanent film such as an overcoat layer, an insulation film or the like.

In permanent films (resists for constitutive components) for use in liquid-crystal displays (LCD) or resists for use in fabricated substrate of electronic materials, the resist is preferably prevented from being contaminated as much as possible with metallic or organic ionic impurities in order that the resist does not interfere with the performance of the products. Accordingly, the concentration of the metal or organic ionic impurities is at most 1000 ppm, preferably at most 100 ppm.

Hereinafter, the method for producing a cured product using the curable composition for imprints of the invention (pattern forming method (pattern transferring method)) will be specifically described.

In the method for producing a cured product of the invention, the composition of the invention is first applied onto the substrate to form a patterning layer.

The method for providing the curable composition for imprints of the invention onto a substrate may be a well known application method through coating of, for example, a dip coating method, an air knife coating method, a curtain coating method, a wire bar coating method, a gravure coating method, an extrusion coating method, a spin coating method, a slit scanning method, etc. The thickness of the patterning method of the composition of the invention may vary depending on the use thereof, and may be from 0.05 μm to 30 μm or so. The composition of the invention may be applied in a mode of multilayer coating. Between the substrate and the patterning method of the composition of the invention, any other organic layer may be formed, such as a planarizing layer, etc. With that, the patterning layer is not kept in direct contact with the substrate, and therefore, the substrate may be prevented from being contaminated with dust or from being scratched. Even if an organic layer is provided on the surface of the substrate, the pattern formed by using the composition of the invention is excellent in adhesiveness to an organic layer.

The substrate or support to which the composition of the invention is applied (preferably coated) is chosen depending on various use, and includes, for example, quartz, glass, optical film, ceramic material, vapor deposition film, magnetic film, reflective film, metal substrate of Ni, Cu, Cr, Fe or the like, paper, spin on glass (SOG), polymer substrate such as polyester film, polycarbonate film or polyimide film, TFT array substrate, PDP electrode plate, glass or transparent plastic substrate, electroconductive substrate of ITO, metal or the like, insulating substrate, semiconductor substrate such as silicon, silicon nitride, polysilicon, silicon oxide or amorphous silicon, which, however, are not limitative. The shape of the substrate is also not specifically limited, and may be tabular or roll. The substrate may be chosen depending on combination with a mold, and may be light-transmissibility or non-light-transmissibility.

Next, in the method for producing a cured product, a mold is pressed against the surface of the patterning layer in order to transfer the pattern onto the patterning layer. By this step, a micropattern preformed on the surface for press of the mold can be transferred to the patterning layer.

In the photoimprint lithography with the curable composition for photoimprints of the invention, a light-transmissive material is selected for at least one of the mold material and/or the substrate. In the photoimprint lithography applied to the invention, the curable composition for photoimprints of the invention is applied (preferably coated) onto a substrate to form a patterning layer, and a light-transmissive mold is pressed against it, then this is irradiated with light from the back of the mold to thereby cure the patterning layer. Alternatively, the curable composition for photoimprints is applied (preferably coated) onto a light-transmissive substrate, then a mold is pressed against it, and this is irradiated with light from the back of the substrate whereby the curable composition for photoimprints can be cured.

The photoirradiation may be attained while the mold is kept in contact with the composition or after the mold is released. In the invention, preferably, the photoirradiation is attained while the mold is kept in contact with the composition.

The mold usable in the invention has a transferable pattern formed thereon. The pattern of the mold may be formed, for example, through photolithography, electronic beam lithography or the like by which a pattern may be formed to a desired processing accuracy. In the invention, however, the mold patterning method is not specifically defined.

Not specifically defined, the light-transmissive mold material for use in the invention may be any one having a desired strength and durability. Concretely, its examples include glass, quartz, light-transparent resin such as PMMA, polycarbonate resin or the like, transparent metal deposition film, flexible film of polydimethylsiloxane or the like, photocured film, metal film, etc.

The non-light-transmissive mold to be used in the invention where a light-transmissive substrate is used is not also specifically defined and may be any one having a predetermined strength. Concretely, examples of the mold material include ceramic material, deposition film, magnetic film, reflective film, metal material of Ni, Cu, Cr, Fe or the like, as well as SiC, silicon, silicon nitride, polysilicon, silicon oxide, amorphous silicon, etc. However, these are not limitative. The shape of the mold is not specifically limited. The mold may be any of a tabular mold or a roll mold. The roll mold is used especially when continuous production by transferring is desired.

The mold for use in the method for producing a cured product of the invention may be processed for surface release treatment for the purpose of enhancing the releasability of the curable composition for photoimprints of the invention from the mold. The mold of the type includes those surface-treated with a silicone-type or fluorine-containing silane coupling agent, for which, for example, commercial release agents such as Daikin's Optool DSX, Sumitomo 3M's Novec EGC-1720 and others are preferred.

In photoimprint lithography using the curable composition for photoimprints of the invention, in general, the mold pressure is preferably at most 10 atmospheres, more preferably 3 atmospheres. When the mold pressure is at most 10 atmospheres, then the mold and the substrate are hardly deformed and the patterning accuracy tends to increase. It is also favorable since the pressure unit may be small-sized since the pressure to be given to the mold may be low. The mold pressure is preferably selected from the region capable of securing the mold transfer uniformity, within a range within which the residual film of the composition in the area of mold pattern projections may be reduced.

In the method for producing a cured product of the invention, the dose of photoirradiation in the step of irradiation with light on the patterning layer may be sufficiently larger than the dose necessary for curing. The dose necessary for curing may be suitably determined depending on the degree of consumption of the unsaturated bonds in the curable composition for imprints and on the tackiness of the cured film.

In the photoimprint lithography applied to the invention, the substrate temperature in photoirradiation may be room temperature; however, the photoirradiation may be attained under heat for enhancing the reactivity. In the former stage of photoirradiation, preferably, the system is kept in vacuum as effective for preventing contamination with bubbles or for preventing the reduction in reactivity owing to contamination with oxygen, and as effective for enhancing the adhesiveness of the curable composition for photoimprints with mold. The system may be subjected to photoirradiation while still kept in vacuum. In the invention, the vacuum degree is preferably from 10⁻¹ Pa to ordinary pressure.

Light to cure the curable composition for photoimprints of the invention is not specifically defined. For example, it includes light and irradiations with a wavelength falling within an amount of high-energy ionizing radiation, near-ultraviolet, far-ultraviolet, visible, infrared, etc. The high-energy ionizing radiation source includes, for example, accelerators such as Cockcroft accelerator, Handegraf accelerator, linear accelerator, betatoron, cyclotron, etc. The electron beams accelerated by such an accelerator are used most conveniently and most economically; however, any other radioisotopes and other radiations are also usable, which are from nuclear reactors, such as γ rays, X rays, α rays, neutron beams, proton beams, etc. The UV sources include, for example, UV fluorescent lamp, low-pressure mercury lamp, high-pressure mercury lamp, ultra-high-pressure mercury lamp, xenon lamp, carbon arc lamp, solar lamp, etc. The radiations include microwaves, EUV, etc. In addition, laser rays for use in microprocessing of semiconductors, such as LED, semiconductor laser ray, 248 nm KrF excimer laser ray, 193 nm ArF excimer laser ray and others, are also favorably used in the invention. These lights may be monochromatic lights, or may also be lights of different wavelengths (mixed lights).

In photoexposure, the light intensity is preferably within a range of from 1 mW/cm² to 50 mW/cm². When the light intensity is at least 1 mW/cm², then the producibility may increase since the photoexposure time may be reduced; and when the light intensity is at most 50 mW/cm², then it is favorable since the properties of the permanent film formed may be prevented from being degraded owing to side reaction. Also preferably, the dose in photoexposure is within a range of from 5 mJ/cm² to 1000 mJ/cm². When the dose is at least 5 mJ/cm², then the photoexposure may be free from a problem of photoexposure margin narrowing and insufficient photoexposure, and also may be free from a problem of unreacted residue adhesion to mold. On the other hand, when the dose is at most 1000 mJ/cm², then it is favorable since the composition may be prevented from being decomposed to degrade the formed permanent film.

Further, in photoexposure, the oxygen concentration in the atmosphere may be controlled to be less than 100 mg/L by introducing an inert gas such as nitrogen or argon into the system for preventing the radical polymerization from being retarded by oxygen.

The method for producing a cured product of the invention preferably comprises heating the cured pattern to cure further (post-bake step) after curing the patterning layer by irradiation with light. The heating can be done before or after releasing the mold from the patterning layer after the irradiation with light. Preferred is heating the patterning layer after releasing the mold. Temperature at the thermal curing of the composition of the invention after irradiation with light is preferably 150 to 280° C., more preferably at 200 to 250° C. The heating time is preferably from 5 to 60 minutes, more preferably from 15 to 45 minutes.

The pattern formed according to the method for producing the cured products is useful as etching resist. In the case of using the curable composition for imprints of the invention as etching resist, using, as a substrate, a silicon wafer in which a thin film of SiO₂ or the like is provided, micropattern is formed on the substrate at nano order level according to the method for producing a cured product. Then, the micropattern is subjected to etching by using hydrogen fluoride in the case of wet-etching or by using an etching gas such as CF₄, to thereby form a desired pattern on the substrate. The curable composition for imprints of the invention is superior in etching resistance to dry etching.

The curable composition for photoimprints of the invention may be prepared by mixing the above-mentioned ingredients followed by filtering the resulting mixture through a filter having a pore size of from 0.05 μm to 5.0 μm to give a solution. Mixing and dissolving the ingredients to give the curable composition for photoimprints may be attained generally at a temperature falling within a range of from 0° C. to 100° C. The filtration may be attained in multiple stages, or may be repeated multiple times. The filtrate may be re-filtered. Not specifically defined, the material for use for filtration may be any of polyethylene resin, polypropylene resin, fluororesin, nylon resin, etc.

The cured product thus formed according to the method for producing a cured product of the invention as described in the above can be used as a permanent film (resist for structural members) for use in liquid-crystal displays (LCD) and others, or as an etching resist. After its production, the permanent film may be bottled in a container such as a gallon bottle or a coated bottle, and may be transported or stored. In this case, the container may be purged with an inert gas such as nitrogen, argon or the like for preventing the composition therein from being degraded. The composition may be transported or stored at ordinary temperature, but for preventing the permanent film from being degraded, it is preferably transported or stored at a controlled temperature of from −20° C. to 0° C. Needless-to-say, the composition is shielded from light to such a level on which its reaction does not go on.

### Examples

The characteristics of the invention are described more concretely with reference to Production Examples and Examples given below. In the following Examples, the material used, its amount and the ratio, the details of the treatment and the treatment process may be suitably modified or changed not overstepping the scope of the invention. Accordingly, the invention should not be limitatively interpreted by the Examples mentioned below.

### [Curable Composition for Imprints]

Curable compositions for imprints were prepared by mixing a photopolymerization initiator, a polymerizable monomer, a sensitizer, a silane coupling agent and a release agent as described in the following tables.

### <(A) Oxime Ester Compound: Photopolymerization Initiator>

PI-1:IRGACURE OXE-01(manufactured by Chiba)
PI-2:CGI-242(manufactured by Chiba)
PI-3:CGI-325(manufactured by Chiba)
PI-5: naphtho franone oxime acetylester (Synthesized product)
PI-6: carbazoyl carbo oxime acetylester (Synthesized product)
PI-8: naphtho franone oxime methyl carbonate (Synthesized product)
PI-9: bromo naphto franone oxime acetylester (Synthesized product)

The above compound of PI-2 is the same compound as OXE-02 which is used in Example of JP-A-2009-128759.

The compounds of PI-5, PI-6 and PI-8 were synthesized by the method in JP-A-2007-231000, and the compound of PI-9 was synthesized by the method in JP-A-2009-134289.

### <Binder Polymer>

B-1: Methacrylic acid/methacrylic acid methyl/styrene were co-polymerized at a weight ratio of 30/30/40 into methyl ethyl ketone (MEK) solvent. The average molecular weight (Mw) thereof was 27000 (polystyrene conversion). It was prepared to be a solid concentration of 30% by weight by MEK.
B-2: Binder polymer B-2, into which a polymerizable group was introduced, was synthesized by adding an equimolar amount of glycidyl methacrylate to the methacrylic acid of B-1, to thereby introduce polymerizable groups. The average molecular weight (Mw) thereof was 31000(polystyrene conversion). It was prepared to be a solid concentration of 30% by weight by MEK.

The binder composition was prepared by adding the solution in the concentration of 30% by weight. The amount of the binder to be added in the tables shows a value which was converted to the amount of the solid ingredient in the binder composition.

### <Non-Oxime Series Photopolymerization Initiator>

PI-10:IRGACURE-184(manufactured by Chiba)

### <(B)Polymerizable Monomer>

M-1:Benzyl Acrylate(Biscoat#160, manufactured by Osaka Organic Chemical Industry Ltd.) Acrylic acid ester monofunctional monomer.
M-2: hexanediol diacrylate (Biscoat#230, manufactured by Osaka Organic Chemical Industry Ltd.) Acrylic acid ester difunctional monomer.
M-3: trimethylolpropane triacrylate (KAYARD M309, manufactured by Nippon Kayaku Co., Ltd.) Acrylic acid ester trifunctional monomer.
M-4:pentaerythritol tetraacrylate (NK ester, A-TMMT, manufactured by Shin-Nakamura Chemical Co., Ltd.) Acrylic acid ester polyfunctional monomer.
M-5: cyclohexyl acrylate (manufactured by Tokyo Chemical Industry Co., Ltd.) Acrylic acid ester monofunctional monomer.
M-6: neopentyl glycol diacrylate (NK ester NPGDA, manufactured by Shin-Nakamura Chemical Co., Ltd.) Acrylic acid ester difunctional monomer.

### <(C) Silane Coupling Agent>

S-1: glycidoxy propyl trimethoxysilane (KBE-403, manufactured by Shin-Etsu Chemical Co., Ltd.)
S-2: γ-acryloyloxy propyl trimethoxysilane (KEN-5103, manufactured by Shin-Etsu Chemical Co., Ltd.) A silane coupling agent comprising a carbon-carbon unsaturated bond.
SA-1: adduct of aminopropyl methoxysilane (KBM-903, manufactured by Shin-Etsu Chemical Co., Ltd.) and butanediol diacrylate (Biscoat #195, manufactured by Osaka Organic Chemical Industry Ltd.) at 1:1 (molar equivalent) A silane coupling agent comprising a carbon-carbon unsaturated bond and an amino group.

### <Sensitizer>

X-1:1-chloro-4-propyloxy thioxanthone (CPTX, manufacuted by Nippon Kayaku Co., Ltd.)
X-2:N-buthyl-2-chloroacrydone (NBCA, manufactured by Tokyo Chemical Industry Co., Ltd.)
X-3:2,4-diethyl thioxanthone(DETX, manufacuted by Nippon Kayaku Co., Ltd.)

### <Release Agent>

W-1:KF-352A(modified silicone, manufactured by Shin-Etsu

Chemical Co., Ltd.)
W-2:KF-410(modified silicone, manufactured by Shin-Etsu Chemical Co., Ltd.)
W-3:MEGAFACE F780F (a fluorine-containing compound, manufactured by DIC Corporation)

### [Evaluation of Curable Composition for Imprints]

Each of compositions for Examples and Comparative Examples was evaluated according to the following evaluation methods.

### <Measurement of Composition Viscosity>

Viscosity of the composition was measured with a rotary viscometer, Toki Sangyo's RE-80L Model, at 25±0.2° C.

The revolution speed in measurement was 100 rpm for a range of from 0.5 mPa·s to less than 5 mPa·s; 50 rpm for a range of from 5 mPa·s to less than 10 mPa·s; 20 rpm for a range of from 10 mPa·s to less than 30 mPa·s; 10 rpm for a range of from 30 mPa·s to less than 60 mPa·s; 5 rpm for a range of from 60 mPa·s to less than 120 mPa·s; 1 rpm or 0.5 rpm for a range of 120 mPa·s or more.

### <Evaluation of Adhesiveness to Substrate>

On a glass substrate having a wide of 26 mm, a curable composition (10 μl) was dropped, and the curable composition was nipped with a glass substrate which is the same as the glass substrate having a wide of 26 mm so that those glass substrates become cross. This was exposed to a light source of a high-pressure mercury lamp (by ORC) (lamp power, 2000 mW/cm²) at an illuminance of 10 mW/cm² and an expose amount of 240 mJ/cm². The two glass substrates were vertically pulled away to each other at a rate of 1 mm/second. The largest peeling force was measured and was determined as adhesiveness. The unit was shown as N (newton).

### <Evaluation of Mold Peelability>

Using a glass substrate which was treated with fluorine series silane coupling agent (2.5×2.5 mm sequare) as a mold, peeling force when the mold is peeled from the substrate was measured in an imprinting device. The curable composition (5 μl) was applied on the glass substrate, the mold was pressured, and then, was exposed to a light source of a high-pressure mercury lamp (by ORC) (lamp power, 2000 mW/cm²) at lighting intensity of 10 mW/cm² and an photoexposure dose of 240 mJ/cm². The substrate and the mold were pulled away to each other at a rate of 20 μm/second. The largest peeling force was measured and determined as peelability. The unit was shown as N (newton)

### <Evaluation of Curing Sensitivity>

The composition was applied onto a glass substrate by spin coating to form a layer having a thickness of 3.0 μm thereon. The spin-coated substrate was set in a nanoimprinting device with a light source of a high-pressure mercury lamp (by CRC) (lamp power, 2000 mW/cm²). The mold for use herein was made of polydimethylsiloxane(Toray Dow-Corning's SILGARD 184, cured at 80° C. for 60 minutes) and had a line/space pattern of 10 μm with a groove depth of 4.0 μm. The device was vacuumed (to a vacuum degree of 10 Torr, about 1.33 kPa), the mold was fitted to the substrate, and the device was purged with nitrogen (1.5 atmospheres, mold pressing pressure). This was photoexposed from the back of the mold under the condition of a lighting intensity of 10 mW/cm² at an interval of 25 mJ/cm². The smallest photoexposure dose was 50 mJ/cm².

Sticky paste sense of the surface of the mold after the mold was peeled was checked with a finger, the photoexposure dose in which the sticky paste sense was not felt was evaluated as the curing sensitivity.

The composition comprising the binder was diluted with methyl ethyl ketone, and then, was applied by spin coating, to thereby form a layer, and the evaluation of the sensitivity was carried out.

TABLE 1

| | Example 1 | | Example 2 | | Example 3 | | Example 4 | | Example 5 | | Example 6 | | Example 7 | |
|---|---|---|---|---|---|---|---|---|---|---|---|---|---|---|
| M-1 | 10 | | 10 | | 20 | | 20 | | 20 | | 20 | | 20 | |
| M-2 | 30 | | 30 | | 36 | | 36 | | 36 | | 36 | | 34 | |
| M-3 | 18 | | 17 | | 40 | | 39 | | 40 | | 40 | | 40 | |
| M-4 | | | | | | | | | | | | | | |
| M-5 | 10 | | 10 | | | | | | | | | | | |
| M-6 | 30 | | 30 | | | | | | | | | | | |
| Polymerization | PI-1 | 2 | PI-2 | 2 | PI-3 | 2 | PI-3 | 2 | PI-5 | 2 | PI-5 | 2 | PI-5 | 2 |
| initiator | | | | | | | | | | | | | | |
| Sensitizer | | | | | | | | | X-1 | 2 | X-1 | 2 | X-2 | 2 |
| Silane coupling | | | | | S-1 | 2 | S-2 | 2 | | | S-1 | 2 | S-2 | 2 |
| agent | | | | | | | | | | | | | | |
| Release agent | | | W-1 | 1 | | | W-1 | 1 | | | | | | |

| | | | | | | | |
|---|---|---|---|---|---|---|---|
| Amount of | 98 | 97 | 96 | 97 | 96 | 94 | 96 |
| polymerizable | | | | | | | |
| monomer | | | | | | | |
| Viscosity | 11 | 10 | 16 | 15 | 16 | 15 | 15 |
| Adhesiveness | 24N | 24N | 25N | 27N | 32N | 36N | 50N |
| Curing | 150 | 150 | 100 | 100 | <50 | <50 | <50 |
| sensitivity | | | | | | | |
| [mJ/cm²] | | | | | | | |

TABLE 2

| | Example 8 | | Example 9 | | Example 10 | | Example 11 | | Example 12 | | Example 13 | | Example 14 | |
|---|---|---|---|---|---|---|---|---|---|---|---|---|---|---|
| M-1 | | | 20 | | 20 | | 20 | | | | 20 | | 20 | |
| M-2 | 30 | | 38 | | 36 | | 36 | | 30 | | 36 | | 34 | |
| M-3 | 30 | | 40 | | 40 | | 40 | | 30 | | 39 | | 44 | |
| M-4 | 10 | | | | | | | | 10 | | | | | |
| M-5 | | | | | | | | | | | | | | |
| M-6 | 25 | | | | | | | | 25 | | | | | |
| Polymerization | PI-5 | 2 | PI-6 | 2 | PI-6 | 2 | PI-6 | 2 | PI-6 | 2 | PI-8 | 2 | PI-9 | 2 |
| initiator | | | | | | | | | | | | | | |
| Sensitizer | X-3 | 2 | | | | | | | | | X-3 | 2 | | |
| Silane coupling | SA-1 | 2 | | | S-1 | 2 | S-2 | 2 | SA-1 | 2 | | | | |
| agent | | | | | | | | | | | | | | |
| Release agent | W-1 | 1 | | | | | | | W-2 | 1 | W-3 | 1 | | |

| | | | | | | | |
|---|---|---|---|---|---|---|---|
| Amount of | 95 | 98 | 96 | 98 | 97 | 95 | 98 |
| polymerizable | | | | | | | |
| monomer | | | | | | | |
| Viscosity | 25 | 15 | 16 | 16 | 24 | 15 | 16 |
| Adhesiveness | >50N | 31N | 37N | 49N | >50N | 30N | 30N |
| Curing | <50 | <50 | <50 | <50 | <50 | <50 | <50 |
| sensitivity | | | | | | | |
| [mJ/cm²] | | | | | | | |

TABLE 3

| | Example 15 | | Example 16 | |
|---|---|---|---|---|
| M-1 | | | | |
| M-2 | 30 | | 30 | |
| M-3 | 30 | | 30 | |
| M-4 | 10 | | 10 | |
| M-5 | | | | |
| M-6 | 25 | | 25 | |
| Polymerization initiator | PI-5 | 2 | PI-6 | 2 |
| Sensitizer | X-3 | 2 | | |
| Silane coupling agent | S-1 | 2 | S-1 | 2 |
| Release agent | W-1 | 1 | W-2 | 1 |

| | | |
|---|---|---|
| Amount of polymerizable | 95 | 97 |
| monomer | | |
| Viscosity | 33 | 35 |
| Adhesiveness | 25N | 27N |
| Curing sensitivity [mJ/cm²] | <50 | <50 |

TABLE 4

| | Comparative | | Comparative | | Comparative | |
|---|---|---|---|---|---|---|
| | Example 1 | | Example 2 | | Example 3 | |
| M-1 | 20 | | 20 | | | |
| M-2 | 38 | | 36 | | 30 | |
| M-3 | 40 | | 40 | | 30 | |
| M-4 | | | | | 10 | |
| M-5 | | | | | | |
| M-6 | | | | | 25 | |
| Polymerization | PI-10 | 2 | PI-10 | 2 | PI-10 | 2 |
| initiator | | | | | | |
| Silane coupling | | | S-2 | 2 | SA-1 | 2 |
| agent | | | | | | |
| Release agent | | | | | W-1 | 1 |

| | | | |
|---|---|---|---|
| Amount of | 98 | 96 | 95 |
| polymerizable | | | |
| monomer | | | |
| Viscosity | 15 | 16 | 33 |
| Adhesiveness | 17N | 22N | 29N |
| Curing | 200 | 220 | 200 |
| sensitivity | | | |
| [mJ/cm²] | | | |

TABLE 5

| | | | | | Comparative | | Comparative | |
|---|---|---|---|---|---|---|---|---|
| | Example 17 | | Example 18 | | Example 4 | | Example 5 | |
| polymerizable | M-1 | 20 | M-2 | 30 | M-1 | 20 | M-1 | 10 |
| monomer | M-2 | 34 | M-3 | 30 | M-2 | 20 | M-2 | 10 |
| | M-3 | 40 | M-4 | 10 | M-3 | 20 | M-3 | 27 |
| | | | M-6 | 25 | | | | |
| Binder polymer | | | | | B-1 | 36 | B-2 | 50 |
| Polymerization | PI-5 | 2 | PI-5 | 2 | PI-5 | 2 | PI-1 | 3 |
| initiator | | | | | | | | |
| Sensitizer | X-3 | 2 | X-3 | 2 | X-3 | 2 | | |
| Silane coupling | | | SA-1 | 2 | | | | |
| agent | | | | | | | | |
| Release agent | | | W-1 | 1 | | | | |

| | | | | |
|---|---|---|---|---|
| Amount of | 96 | 95 | 60 | 47 |
| polymerizable | | | | |
| monomer | | | | |
| Peelability | 3.0N | 2.7N | 5.2N | 7.8 |

| | | | | |
|---|---|---|---|---|
| Curing | <50 | <50 | <50 | <50 |
| sensitivity | | | | |
| [mJ/cm²] | | | | |

As is clear from the above results, it was found that the curable composition for imprints which has low viscosity and high adhesiveness to a substrate can be obtained by using an oxime ester compound as a polymerization initiator.

As is clear from the result for Examples 1 and 2, the composition of the invention does not become poor in adhesiveness to a substrate even if a release agent is added into the composition. Thus, it was found that the invention can achieve both of peelability from a substrate (peeling force) and adhesiveness to a substrate which are opposite effects to each other.

As is clear from the comparison of Examples 1 and 3, addition of a silane coupling agent improves the adhesiveness to a substrate by 1N. As is clear from the comparison of Examples 3 and 4, the adhesiveness to a substrate is further improved by 1N by using a silane coupling agent comprising a carbon-carbon unsaturated bond (S-2) as a silane coupling agent. Such improvement is not based on the effect of simply adding a silane coupling agent, but is based on the synergetic effect by combining with oxime ester. Especially, as is clear from the comparison of Examples 8 and 15 and the comparison of Examples 12 and 16, double improvement of the adhesiveness to a substrate is achieved by using a silane coupling agent comprising a carbon-carbon unsaturated bond and an amino group. Therefore, it was found that the improvement of the adhesiveness to a substrate is remarkable.

As is clear from the comparison of Example 15 and Comparative Example 3, it was found that the peeling force can be reduced by increasing the amount to be added of polymerizable monomers in the composition.

While the invention has been described in detail and with reference to specific embodiments thereof, it will be apparent to one skilled in the art that various changes and modifications can be made therein without departing from the spirit and scope thereof.

The present disclosure relates to the subject matter contained in Japanese Patent Application No. 213408/2009 filed on Sep. 15, 2009, which is expressly incorporated herein by reference in its entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is;:

1. A curable composition for imprints comprising an oxime ester compound (A) and a polymerizable monomer (B), wherein the content of the polymerizable monomer (B) falls within a range of 80% by mass or more, relative to all ingredients of the composition except for a solvent.

2. The curable composition for imprints according to claim 1, which further comprises a silane coupling agent (C).

3. The curable composition for imprints according to claim 1, which further comprises a silane coupling agent (C) having a carbon-carbon unsaturated bond.

4. The curable composition for imprints according to claim 1, which further comprises a silane coupling agent (C) having a carbon-carbon unsaturated bond and a nitrogen atom.

5. The curable composition for imprints according to claim 1, which further comprises a silane coupling agent (C) having a carbon-carbon unsaturated bond and an amino group.

6. The curable composition for imprints according to claim 1, wherein the oxime ester compound (A) is a compound represented by the following formula (1), or a compound represented by the following formula (2): 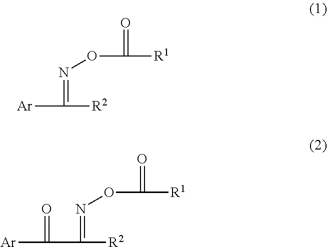
wherein Ar is a hydrocarbon series aromatic ring or a heteroaromatic ring, R¹ is an alkyl group, an aromatic group, or an alkoxy group, R² is a hydrogen atom or an alkyl group, and R² may bond to Ar to form a ring.

7. The curable composition for imprints according to claim 1, wherein the oxime ester compound (A) is a compound represented by the following formula (3), a compound represented by the following formula (4), or a compound represented by the following formula (5): 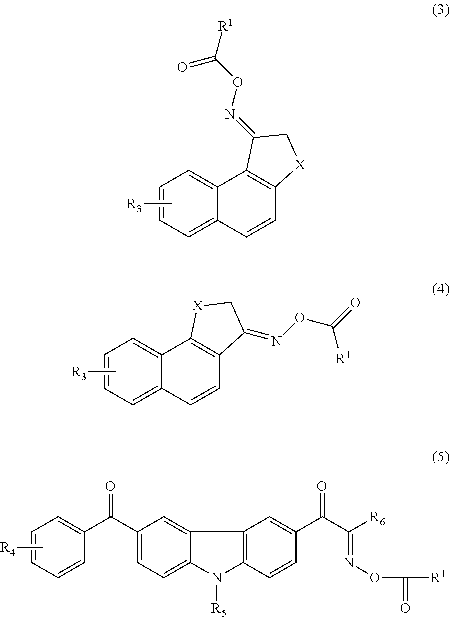
wherein R¹ is an alkyl group, an aromatic group, or an alkoxy group, X is —CH₂—, —C₂H₄—, —O—, or —S—, R³ is a hydrogen atom, or a halogen atom, R⁴ is a hydrogen atom, an alkyl group, a phenyl group, an alkyl-substituted amino group, an arylthio group, an alkylthio group, an alkoxy group, an aryloxy group, or a halogen atom, R⁵ is a hydrogen atom, an alkyl group, or an aryl group, and R⁶ is an alkyl group.

8. The curable composition for imprints according to claim 1, wherein the polymerizable monomer (B) is a (meth)acrylate.

9. The curable composition for imprints according to claim 1, which further comprises a release agent.

10. The curable composition for imprints according to claim 1, which has a viscosity of from 3 to 30 mPa·s.

11. The curable composition for imprints according to claim 1, which further comprises a sensitizer.

12. The curable composition for imprints according to claim 2, wherein the content of the silane coupling agent falls within a range of 0.1 to 20% by mass, relative to all ingredients of the composition except for a solvent.

13. The curable composition for imprints according to claim 1, wherein the oxime ester compound (A) is selected from the following PI-1 to PI-9:

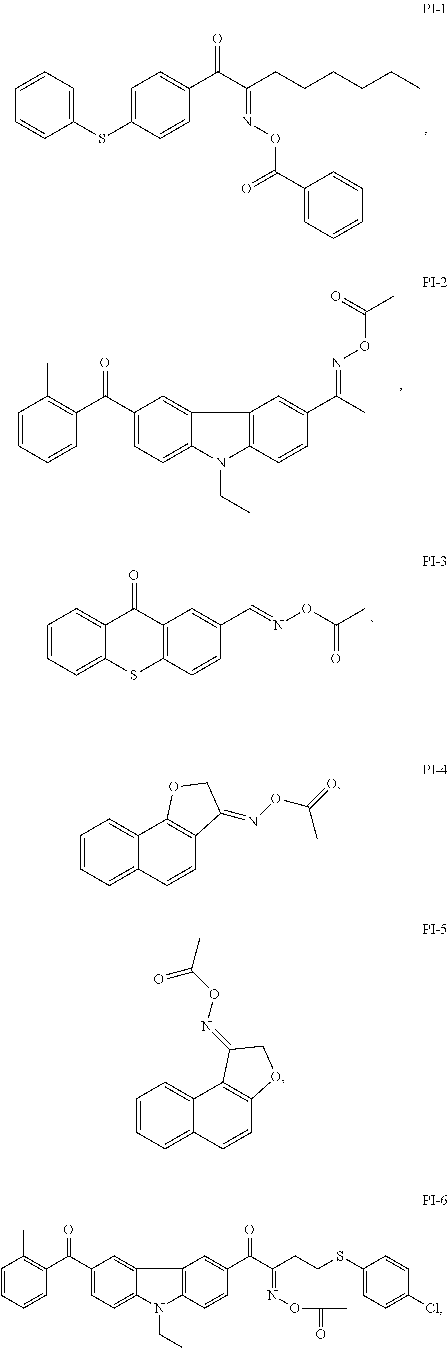

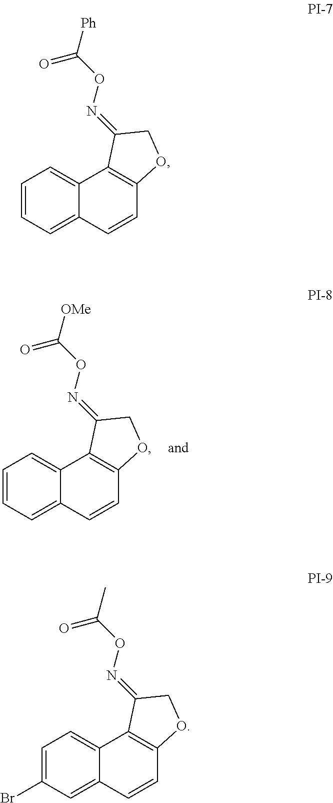

14. The curable composition for imprints according to claim 2, wherein the silane coupling agent is selected from the following SA-1 to SA-3:

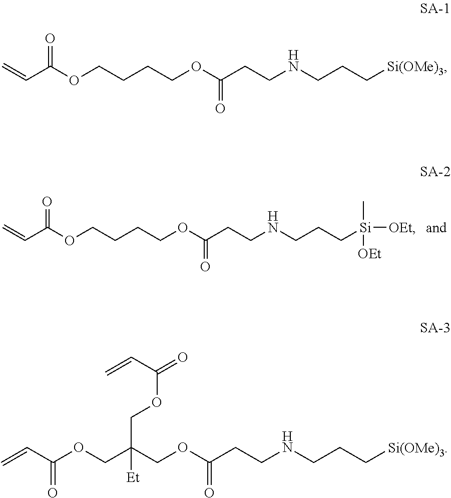

15. The curable composition for imprints according to claim 1, wherein the content of the oxime ester compound falls within a range of 0.1 to 5% by mass, relative to all ingredients of the composition except for a solvent.

16. The curable composition for imprints according to claim 1, wherein the content of the oxime ester falls within a range of 0.1 to 5% by mass, relative to all ingredients of the composition except for a solvent, and the oxime ester compound (A) is a compound represented by the following formula (3), a compound represented by the following formula (4), or a compound represented by the following formula (5): 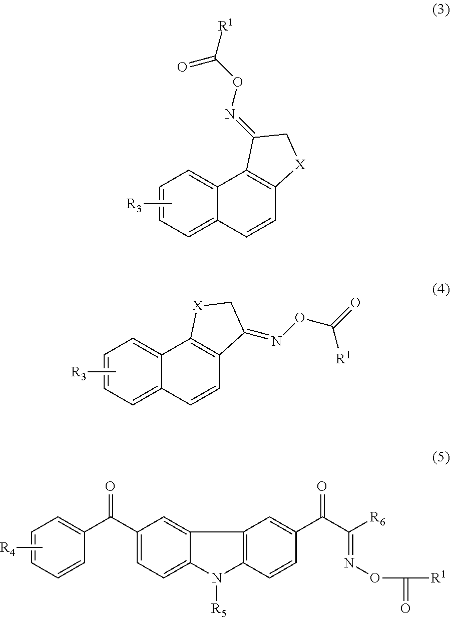
wherein R¹ is an alkyl group, an aromatic group, or an alkoxy group, X is —CH₂—, —C₂H₄—, —O—, or —S—, R³ is a hydrogen atom, or a halogen atom, R⁴ is a hydrogen atom, an alkyl group, a phenyl group, an alkyl-substituted amino group, an arylthio group, an alkylthio group, an alkoxy group, an aryloxy group, or a halogen atom, R⁵ is a hydrogen atom, an alkyl group, or an aryl group, and R⁶ is an alkyl group.

17. The curable composition for imprints according to claim 1, wherein the content of the oxime ester falls within a range of 0.1 to 5% by mass, relative to all ingredients of the composition except for a solvent; the oxime ester compound (A) is a compound represented by the following formula (3), a compound represented by the following formula (4), or a compound represented by the following formula (5): 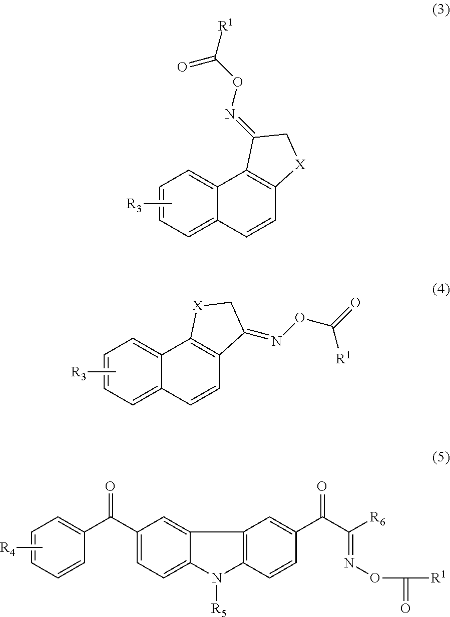
wherein R¹ is an alkyl group, an aromatic group, or an alkoxy group, X is —CH₂—, —C₂H₄—, —O—, or —S—, R³ is a hydrogen atom, or a halogen atom, R⁴ is a hydrogen atom, an alkyl group, a phenyl group, an alkyl-substituted amino group, an arylthio group, an alkylthio group, an alkoxy group, an aryloxy group, or a halogen atom, R⁵ is a hydrogen atom, an alkyl group, or an aryl group, and R⁶ is an alkyl group; and
which further comprises a silane coupling agent (C) having a carbon-carbon unsaturated bond and an amino group.

18. A cured product, obtained by curing a curable composition for imprints comprising an oxime ester compound (A) and a polymerizable monomer (B), wherein the content of the polymerizable monomer (B) falls within a range of 80% by mass or more, relative to all ingredients of the composition except for a solvent.

19. A method for producing a cured product, which comprises applying a curable composition for imprints onto a substrate to form a patterning layer thereon, pressing a mold against the surface of the patterning layer, and irradiating the patterning layer with light; and
wherein the curable composition for imprints comprises an oxime ester compound (A) and a polymerizable monomer (B), and the content of the polymerizable monomer (B) falls within a range of 80% by mass or more, relative to all ingredients of the composition except for a solvent.

20. The method for producing a cured product according to claim 19, which further comprises heating the light-irradiated pattering layer.
